(19) United States
(12) Patent Application Publication
(10) Pub. No.: US 2004/0158564 A1
(43) Pub. Date: Aug. 12, 2004

(54) System and method for facilitating information transformations

(75) Inventors: James Robert Angus Collier, Welington (NZ); Alexander Robert Bould, Christchurch (NZ); Mark Leslie Cox, Christchurch (NZ)

Correspondence Address: DARBY & DARBY P.C., P. O. BOX 5257, NEW YORK, NY, 10150-5257, US

(73) Assignee: Fifth Web Limited, Christchurch (NZ)

(21) Appl. No.: 10/684,347

(22) Filed: Oct. 10, 2003

Related U.S. Application Data
(63) Continuation of application No. PCT/NZ02/00074, filed on Apr. 12, 2002.

(30) Foreign Application Priority Data
Apr. 12, 2001 (NZ) 511140

(51) Int. Cl. G06F 17/30

(52) U.S. Cl. 707/10

(57) ABSTRACT

A method of performing an information transformation (T1-T4) within a communications network is provided. The information transformation (T1-T4) has one or more information objects (OA-OE, O1-O5) as inputs and the method includes providing in or associated with an output of said information transformation, tracking information that uniquely identifies all inputs to the transformation. Also provided is a system for locating a copy of a required information object within a communications network. The system records the location of copies of required information objects (OA-OE, O1-O5) within the communications network (1) and provides information referring to a network location of at least one copy upon request. A unique identifier of the required information object is used to verify the integrity of the information object.

### BACKGROUND OF THE INVENTION

This invention relates to a system and method for facilitating information transformations in a network environment and in particular, but not exclusively, to a system and method for facilitating information transformations in a peer-to-peer network environment.

Recently, systems and methodologies have emerged that further take advantage of the communication abilities of the Internet. These systems and methodologies include peer-to-peer networking which allows access to the contents and/or processing capabilities of individual terminals of the network by others. The access provided by peer-to-peer systems provides considerable advantages in information transformations, as the entire system may effectively collaborate to take best advantage of the available information and resources.

The potential applications of peer-to-peer networking to electronic commerce have been widely recognised. The increased availability of information alone may provide significant competitive advantage over more traditional electronic commerce techniques.

However, a problem with peer-to-peer network systems is providing a suitable auditing methodology, as the potential for information to become disassociated with its originator and other related information becomes higher with the increased complexity of the information transformations. Furthermore, a problem with larger networks is locating and accessing a particular document. Even after a document has been located, if it is on a particularly busy server, obtaining bandwidth to access the information may be difficult.

An object of an embodiment of the present invention is to provide a system and/or method for facilitating information transformations that is suitable for providing transformation auditing information and/or may be used to locate copies of documents in a network, which overcome or alleviate problems in network systems at present, or at least provide the public with a useful alternative.

Other objects of the present invention may become apparent from the following description.

### SUMMARY OF THE INVENTION

Throughout the following description the words “information transformation(s)” have been used in reference to the communication, manipulation or input of any information object in a network environment. The information object may be in any form, such as a data object, instruction set, or application output, and include information relating to, but not limited to, operational, managerial, research, policy, financial and e-commerce information.

According to one aspect of the present invention, there is provided a method of performing an information transformation within a communications network, wherein the information transformation has one or more information objects as inputs, the method including providing in or associated with an output of said information transformation, tracking information that uniquely identifies all inputs to the transformation.

According to another aspect of the present invention, there is provided a method of performing transformations of information objects within a communications network, the method including:

associating with each said information object a determinable unique identifier;

receiving as inputs to an information transformation one or more information objects and producing an output including one or more information objects; and

providing in or with said output, tracking information from which the unique identifier of each information object received as an input to said information transformation may be determined.

Preferably, the method may further include providing in said output, information that uniquely identifies the information transformation.

Preferably, the method may further include providing said tracking information within a protected part of said output.

Preferably, at least selected information objects may include protected information including one or more protection measures to prevent or notify of any unauthorised modification or deletion of said protected information, wherein said unique identifier is determined dependent on said protected information.

Preferably, said tracking information may form part of said protected information used for determining said unique identifier.

Preferably, said tracking information may be time-invariant.

Preferably, said unique identifier may be determined by performing a hash computation on said protected information.

Preferably, the method may include allocating a unique identifier to said information transformation and including within said tracking information the unique identifier of the said information transformation.

Preferably, the method may further include providing a resource indicator within or associated with said output that specifies a context of the input information objects for use in identifying where or how said input information objects may be found within the network.

Preferably, said resource indicator may include a reference to a specific namespace that an information object is associated with.

Preferably, said resource indicator may include a reference to a specific application of the information object.

According to another aspect of the present invention, there is provided apparatus for information object transformation within a communications network including:

processing means including one or more input means, and at least one output means for receiving and outputting one or more information objects to and from a communications network respectively; and

storage means readable by said processing means and including instructions to cause said computer processing means to transform information objects received at said input means, produce one or more output information objects at said output means and include within or associate with the or each output information object tracking information that uniquely identifies all said received information objects.

Preferably, said storage means may further include instructions to cause said processing means to include information that uniquely identifies the information transformation within said tracking information.

Preferably, said storage means may further include instructions to cause said processing means to protect predetermined information within said output information object and include within said predetermined information said tracking information.

Preferably, said storage means may further include instructions to cause said processing means to include within said tracking information a resource indicator that specifies a context of said input information objects for use in identifying where or how said input information objects may be found within the network.

Preferably, said resource indicator may include a reference to a specific namespace that an information object is associated with.

Preferably, said resource indicator may include a reference to a specific application of the information object.

According to another aspect of the present invention, there is provided apparatus for locating a copy of a required information object within a communications network, the apparatus including:

one or more resolvers adapted to record the location of copies of said required information object within said communications network and provide information referring to a network location of at least one copy upon request; and

information object retrieval means adapted to retrieve a copy said required information object from said network location;

processing means to compute a first unique identifier of said required information object based on the content of a retrieved copy of said required information object and compare said unique identifier with a second unique identifier computed from the required document.

Preferably, the or each resolver may also be adapted to record a unique identifier of each information object that it records the location of copies of and supply said unique identifier when providing information referring to a network location of a copy of an information object.

Further aspects of the present invention may become apparent from the following description which is given by way of example only and with reference to the accompanying drawings.

### BRIEF DESCRIPTION OF THE DRAWINGS

FIG. 1 shows a simplified block diagram of a computer network including apparatus in accordance with an aspect of the present invention.

FIG. 2 shows a flow diagram of a series of information transformations using the network of FIG. 1.

### MODES FOR PERFORMING THE INVENTION

The present invention relates to a method of conducting information transformations in a network environment, with particular application envisaged for networked systems operating using peer-to-peer communication methodologies.

Communication of information between terminals or nodes within a peer-to-peer networked system and within other large networks is typically complex and the information in the system typically is dynamic, with a high rate of change. This creates difficulties in identifying where information from within the network is sourced. The present invention includes allocating a unique identifier to each information object within the networked system. Furthermore, each information transformation may have a unique identifier which is provided in or associated with its output to enable subsequent identification of the information transformations performed on a particular output.

It will be appreciated by those skilled in the art that a unique identifier in terms of computer networks may in fact not be totally unique. However, it is sufficient that the probability of a conflict occurring due to two different information objects having the same identifier is very small and thus may be treated for most practical purposes to be negligible. Thus, the terms “unique” and “uniquely” are intended to cover such identifiers with a very small chance of conflict and should be so interpreted herein.

In typical networked communication systems, an information object may be communicated, modified or otherwise transformed by many information transformations. A unique identifier within the information objects produced according to the present invention allows the preceding information transformations and their inputs to be determined. This information may be used for analysis purposes, including, but not limited to auditing, discovery of operations, monitoring, exception processing, within quality systems or in the delivery of products or services. Thus, the overall effect is to increase the visibility of information transformations within a network.

The following description is given with reference to a computer network operating as a product ordering and dispatch system. However, it will be appreciated by those skilled in the art that application of the present invention may be found in any networked system requiring information transfer and transformations.

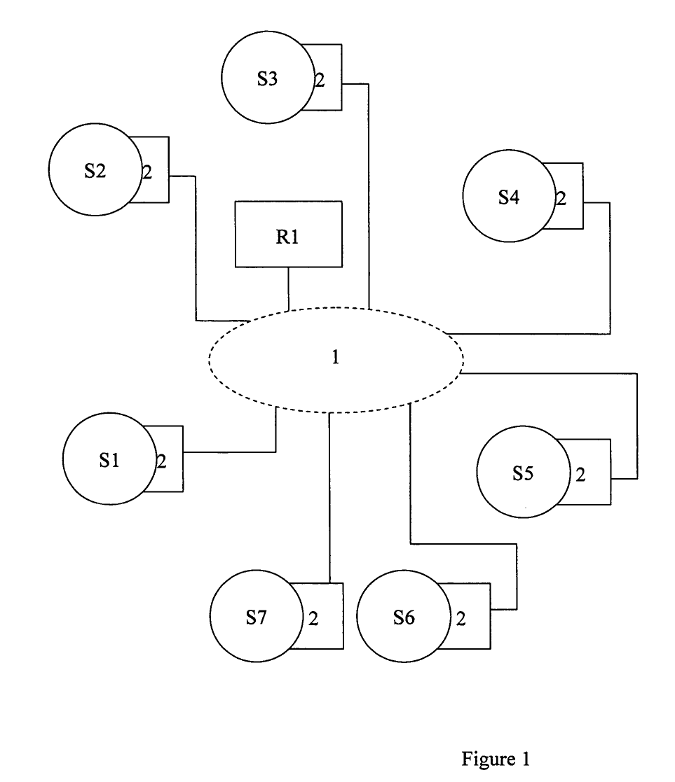

Referring to the accompanying FIG. 1, a simplified block diagram of a computer network system in which the present invention may be implemented is shown. The network 1 includes five nodes. These nodes may be any apparatus that can communicate with the network 1 to provide information to the network. Thus, herein the nodes are referred to as sources, with FIG. 1 showing five sources S1-S5. Each source S1-S5 includes a network interface 2 to facilitate information communications with the network, or more particularly with other sources in the network through the network. The present invention may have application to many networks, the only requirement on the network is that end points (cellphones, PDAs, computers) are uniquely addressable either globally (ESNs on cellphones, MACs on Ethernet cards) or via a gateway (e.g. NAT in private IP networks) and that any logical addressing scheme (phone numbers, IP addresses or DNS entries) must be resolvable to a unique network/device specific address for the endpoint, typically on demand. The underlying network may therefore may include, for example personal networks (blue-tooth), telephony networks, wireless networks, voice recognition networks, and device networks. Each or some of the sources S1-S5 may be able to perform information transformations as herein above defined.

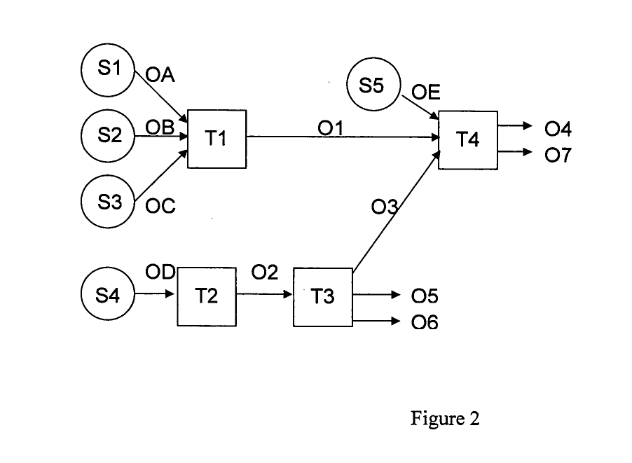

Referring to FIG. 2, a flow diagram of an example of a series of information transformations is shown. The computer network system in this example performs four information transformations T1-T4. Information transformations include, as hereinabove defined any information communication, manipulation or input of any information object. Any of the sources S1-S5 may be used to perform an information transformation, or another device, such as a router may be used. The network administrators can choose which devices add unique identifiers to their output and which do not. In addition, each device may perform some transformations that have unique identifiers and some transformations that do not.

In reference to the example of a product order and distribution system, transformations T1 and T2 may involve receiving product order information, in this case from five sources S1-S5, and storing the product order information in memory. The transformation T1 may have sources S1-S3 located in one geographical area, whereas T2 may have source S4 located in another geographical area, requiring different treatment to sources S1-S3.

The product order information OA-OD from sources S1-S5 may be interpreted as an information object. Therefore, the present invention involves allocating at least one unique identifier to each product order information OA-OD. Similarly, the process of inputting information may be interpreted as an information transformation and hence each source S1-S5 may optionally have a unique identifier. The information transformation of inputting new information to the network does not necessarily require identification by a unique identifier. However, the following description assumes that it is required, so as to enable identification the inputting device(s) for information objects within the network. In this embodiment, a unique identifier is added to the information object at the source in the same manner as an information transformation described herein below. The unique identifier for each information object is generated by a computer processor in the source S1-S5 that creates the product order information. The unique identifier of each source S1-S5 may be added each time an information object is inputted to the network (optionally including when the information is stored locally at the inputting source).

In one embodiment, a unique identifier may simply be a random number. The random number set must be of sufficient size (or bits) so that the chance of two information objects being allocated the same number is very small. The size of the random number set should be determined depending on the requirements for the network in question. This unique identifier may be included in or associated with the corresponding information object so as to be discoverable after receipt of the information object. To verify that the information object is from a particular source, the number within or associated with the information object is compared to the number obtained from the initial source or publisher of the information. The random number may be held in a protected part of the information object, to assist in the prevention of fraud.

The information object, being the product order information may include protected information, protected against unauthorised access, modification and/or deletion. This protection may be achieved, for example through the use of a digital signature algorithm in accordance with a specified signing protocol. The protected information within the product order information may include, for example the identity of each source S1-S5, the quantity of the products ordered and/or the identity of the products ordered.

This protected information may be used to generate a unique identifier for the product order information object. The unique identifier may be determined by computing a hash function of the protected information, for example by taking an MD5 hash of the protected information. A predetermined portion of the protected information may be used if required to reduce the computational burden on the system.

The formation of the unique identifier from the protected information of an information object allows ready identification of the unique identifier anywhere in a networked system and does not require the unique identifier to be included with or associated with the information object, as all the information required to determine the unique identifier is inherently part of the information object. As the protected information by its very nature is unchanging, all that is required is knowledge of the function that generates the unique identifier, in this example an MD5 hash. Thus, the unique identifier can be determined anywhere at the network at any time and used to verify the integrity of an information object. Thus, it is envisaged that using the protected information for generation of the unique identifiers is preferable over generating a random number.

In an alternate form of the invention, unprotected information may be used to generate the unique identifier. However, this is a less preferred option due to decreasing the flexibility of use of each information object and increasing computational burden. A unique identifier that is a combination of parts determined from the content of the information object and otherwise may also be used.

Each information transformation may also have a unique identifier associated with it. For example, in a product order scenario shown in FIG. 2, transformations T1 may involve collating the orders from sources S1-S3 into a single order, based on geographic location. The formatting functions and simple addition operations of the transformation T1 may be protected from modification or deletion and priority information may be protected from access, modification or deletion. Thus, the transformation has content and may include protected information, making it suitable for generating a unique identifier in the same manner as for an information object.

The output of each transformation is also an information object in its own right and therefore is also allocated its own unique identifier. In the embodiment utilising a random number as the unique identifier or other unique identifier not solely dependent on the content of an information object, whether or not a unity transformation (i.e. the simple transfer of an information object from one logical location to another) results in the output being allocated a new number is matter of network design choice. In FIG. 2, transformation T2 may be a unity transformation, with O2 being equivalent to OD.

The unique identifier (whether it is a random number, the result of a hash computation from the protected information of the information object or otherwise) of each, or at least selected information objects used as an input to a transformation, is added to or associated with the information object that is outputted from a transformation. Optionally the unique identifier of the transformation is also added. For example and with reference to FIG. 2, each information object OA-OC may include the unique identifier of S1-S3 respectively and the information object at output O1 has the unique identifier of each of the information objects OA-OC that were used as inputs to transformation T1 within or associated with it and optionally further has the unique identifier of the transformation T1. When the information object at output O1 is passed through transformation T4 to produce outputs O4 and O7, the unique identifiers of T4, O1, O3 and OE are added to both these outputs. The transformation may also be one to many, for example transformation T3, in which case both outputs O5 and O6 have the unique identifiers of T3 and O2 within or associated with them.

To determine whether a first information object or transformation was directly used to form a second information object (i.e. whether the first information object is a parent of the second information object or whether a particular transformation was used on a parent to reach the second information object), the unique identifier of the first information object or transformation is determined and compared with those contained within or associated with the second information object for a match. If a match exists, then the first information object is a parent of the second information object.

If the identity and location of the parents is unknown, a search of the entire network must be performed to find the information object that has the correct unique identifier. The large number of information objects within the network may quickly render this trial and error method of computing a unique identifier and comparing it to those in the child information object unworkable for anything larger than the simplest of networks. Also, for information objects with a large number of parents, the storage space and bandwidth required to store and communicate the large number of unique identifiers within or associated with these information objects may be disadvantageous.

Therefore, in combination with the unique identifier, a type of Universal Resource Identifier (URI) may be included with each information object. The information contained within such a URI may vary. One form of a URI may only specify a context, which provides a way of identifying a segment of the network namespace, normally aligned to an individual or organisation. Another form of a URI may specify a context and an object reference, for example, the context may be a specific server and the object reference a particular information object on that server. A still further form of a URI may specify an object reference only, without a context, implying that the object can be used on any server or perhaps in a default context.

In the present invention, the URI is used to specify the location of the parent or parents of an information object. If a context only URI is used, the parents are identified by determining the unique identifier of each information object specified by that context and comparing that to the unique identifiers within or associated with the child until a match is found. For example, if the context specifies a particular server, that server is searched for an information object that has a unique identifier equal to that within or associated with the child information object in question. If a context and object reference URI is used, the only step required is to verify that the unique identifiers match and this step is only required if such verification is necessary. If an object only URI is used, a suitable search strategy may be implemented to find the parent or an equivalent, which may depend on the object specified. A form of URI's may also be used to specify the location of transformations. The location of applications or algorithms used to perform the transformation may be specified.

If a matching unique identifier is not found, an error message may be generated to the initiator of the search and/or alternative search strategies may be implemented. It will be appreciated that the matching of the unique identifier ensures that the correct parent is identified and especially in the case where the unique identifier is generated based on the content of the object, that the parent has not been altered since its use in a transformation to create the child information object.

Since the parents, by definition are invariably determined at the creation of each information object, the unique identifier and/or URI may be used to back-track through a network, progressively finding earlier and earlier parents to the limit of finding the primary information entered into the network. In this manner, complete knowledge of the source of an information object is determinable. Referring to FIG. 2, the information object of outputs O5 and O6 will have a URI and unique identifier within associated with it that identifies O2. O2 in turn identifies OD. Optionally O5 and O6 may have a unique identifier and/or URI for transformation T3, O2 may have a unique identifier and/or URI for transformation T2 and OD may have a unique identifier and/or URI for source S4. Thus, each information object only requires the unique identifiers of each information object that is an immediate parent, optionally the unique identifier of the transformation that formed the information object, and the URI's of those parents (and transformation) to enable auditing of the system.

Since the unique identifiers of child information objects and parent transformations are used to verify the identity and/or integrity of the parents of an information object, the integrity of the unique identifiers is preferably protected against unauthorised modification or deletion. Furthermore, the unique identifiers may be protected against unauthorised viewing, with an application only returning whether or not a match exists. That application itself may be protected against unauthorised use.

Furthermore, the URI's may be protected if required to only allow authorised persons to track an information object within a network. This may be of importance for security and privacy purposes. Access to the URI to enable the location of parents to be determined may be restricted. Like the unique identifiers, an application may use the URI without showing the searcher the URI by automatically searching or sending a request to search the required location and only notifying the user of the result.

Therefore, the unique identifier(s) and/or the URI(s) of parent information objects may be included within protected or immutable information of their children. In the embodiment where the unique identifiers of the children is computed from their immutable information, these then influence the unique identifiers. Thus, even unity transformations result in a different unique identifier of the child from the parent if the unique identifier of the unity transformation is added to the immutable information of the child. Alternatively, the unique identifier(s) and URI(s) may be protected and not be part of the information used to generate the unique identifier.

The process may be reversed to find children of an information object. However, as the immutable information of an information object is preferably fixed at the time of creation of the information object a slightly different system is used.

When one or more children are created from one or more parents through a transformation, the unique identifiers of the children are stored and associated with the parent. In one embodiment, the identities of the one or more children may be stored in, or added as, an unprotected part of the parent. Alternatively, a separate, more centralised database, such as a relational database that can store a many-to-many relationship may record the children of each parent. The relationship may be verified by verifying that the parent unique identifier is part of the protected information of the children.

Thus, the present invention provides a method of identifying each information object and to track its parents and children through the network. This increases visibility of the network to all users and provides protection against unauthorised modification of network content.

The use of a unique identifier that is dependent on the content of an information object to verify the integrity of an object has application in locating copies of a document within a network. If multiple copies are available from various sources, the unique identifier may be used to verify the integrity of the information object and thus verify that it is the same as the information object originally published. This avoids the necessity to access the originally published information object.

A resolver may be used to keep a record of the logical location of copies of an information object. This resolver may then receive requests from a third party to identify the location of a copy (or the original) of the required information object so that the third party may obtain the information from the most convenient source. The most convenient source may be determined by testing, or according to a predefined set of rules, for example referring to a server in the same general geographic location as the third party. Once a copy has been retrieved by the third party, they may compute the unique identifier of the copy and compare that with a unique identifier computed from the original. If they match, then the third party can be confident that the information they have retrieved is genuine and has its integrity in tact.

Preferably, the resolver also records the unique identifier and supplies this information when referring the third party to the location of a copy. Even if the resolver refers the third party to the original information object, the third party may still verify the integrity of the document to ensure it was not corrupted with during the transfer.

The resolver maps logical representations of end points such as cellphones, PDAs, and/or computers to either alternative logical representations of end points or to a representation of end point that provides a means to interact directly with an endpoint. An end point may be a physical or logical node or an object or content hosted by the node.

Referring to FIG. 1, a centralised resolver R1 is shown. However, the resolver may be distributed and may or may not have hierarchical elements to its distribution. The centralisation, decentralisation trade off is typically one of performance/scalability versus latency. If the resolver is centralised the latency for changes to propagate is zero but the performance is correspondingly impacted as the number of nodes referencing the resolver increases—with something as large as the internet a centralised resolver would fail under the weight of use. If the resolver is decentralised then the performance can be maintained but at the expense of latency for changes to propagate. In an hierarchical model (e.g. DNS) sub domains (parts) of the namespace are delegated to authoritive (centralised) nodes and then cached by other nodes as required.

A resolver may form part of the fabric required in a transport network (e.g. IP for the Internet), part of the network created by the deployment of nodes (e.g. DNS for the Internet), and/or part of the peer-to-peer application network created by the deployment of applications on the nodes of a network. The resolver records the transfer of information and the unique identifiers of information transferred so that it can inform a third party of the location of a convenient copy of the information.

A resolver at one layer may use resolvers at any other layer either sequentially or recursively to determine a means to interact directly with an endpoint. The resolver may search the network for copies of information objects and identify matching documents by their unique identifiers.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. A method of performing an information transformation on one or more input information objects within a communications network, the method including:
receiving as an input to said information transformation one or more said input information objects and producing an output including one or more output information objects;
determining for each input information object a unique identifier for that input information object;
providing in the content of said one or more output information objects tracking information from which the unique identifier of each information object received as an input to said information transformation is determinable.

2. The method of claim 1, wherein at least selected information objects include protected information including one or more protection measures to prevent or notify of any unauthorised modification or deletion of said protected information and wherein said unique identifier is determined dependent on said protected information.

3. The method of claim 1 further including providing in the content of said one or more output information objects, information that uniquely identifies said information transformation.

4. The method of claim 2, further including providing said tracking information within a protected part of said one or more output information objects.

5. The method of claim 4, wherein said tracking information forms part of the protected information used for determining said unique identifier.

6. The method of claim 5, including determining said unique identifier by performing a hash computation on said protected information.

7. The method of claim 1, wherein said tracking information is time-invariant.

8. The method of claim 1 further including providing one or more resource indicators within or associated with said one or more output information objects that identifies where or how said one or more input information objects may be found within the network.

9. The method of claim 8, wherein said one ore more resource indicators includes a reference to a specific namespace that the one or more input information objects is located.

10. The method of claim 8, wherein said resource indicator includes a reference to a specific location of the one or more input information objects.

11. The method of claim 8 further including providing one or more resource indicators within or associated with said one or more output information objects that identifies where or how said information transformation may be found within the network.

12. The method of claim 1 further including recording with each said input information object a unique identifier of each output information object.

13. The method of claim 1 further including storing in a storage means locations of copies of information objects and providing one or more locations to a user upon request.

14. The method of claim 13 further including storing in said storage means the unique identifiers of each information object and providing to said user with said one or more locations the unique identifier of the information objects that the locations refer to.

15. The method of claim 14 further including providing to said user the location of a copy of an information that is relatively easily accessible to that user when more than one copy is available.

16. Apparatus for information object transformation within a communications network, the apparatus including:
processing means including one or more input means and at least one output means for receiving and outputting one or more information objects to and from a communications network respectively; and
storage means readable by said processing means and storing instructions to cause said processing means to transform information objects received at said input means, produce one or more output information objects at said output means and include within the content of the or each output information object tracking information that uniquely identifies all said information objects received at said input means.

17. The apparatus of claim 16, wherein said storage means further includes instructions to cause said processing means to include information that uniquely identifies the information transformation within said tracking information.

18. The apparatus of claim 16, wherein said storage means further includes instructions to cause said processing means to protect predetermined information within said output information object and include within said predetermined information said tracking information.

19. The apparatus of claim 16, wherein said storage means further includes instructions to cause said processing means to include within said tracking information a resource indicator that specifies a context of said input information objects for use in identifying where or how said input information objects may be found within the network.

20. The apparatus of claim 19, wherein said resource indicator includes a reference to a specific namespace that an information object is associated with.

21. The apparatus of claim 19, wherein said resource indicator includes a reference to a specific location of the information object within a network.

22. A computer program for performing an information transformation on one or more input information objects the computer program including instructions to cause a computer processing means to receive said one or more input information objects, produce one or more output information objects and include within the content of the or each output information object tracking information that uniquely identifies all said received information objects.

23. The computer program of claim 22, further including instructions to cause said computer processing means to include a reference to the logical location of said input information objects within or associated with each output information object.

24. Apparatus for providing directions to a user where to obtain a copy of an information object in a communications network when multiple copies exist, the apparatus including:
means to record the location of copies of said information object within said communications network and record a unique identifier associated with the information object; and
means to provide information referring to a network location of at least one copy of the information object together with said unique identifier to said user upon request from the user.

25. The apparatus of claim 24 wherein said means to provide information referring to a network location of at least one copy of the information object includes means to evaluate and send a conveniently located copy for said user.

26. A system for locating a copy of a required information object within a communications network including:
means to record the location of copies of said required information object within said communications network and provide information referring to a network location of at least one copy upon request;
information object retrieval means for retrieving a copy said required information object from said network location; and
processing means to compute a first unique identifier of said required information object based on the content of a retrieved copy of said required information object and compare said unique identifier with a second unique identifier computed from the required document.

27. The system of claim 26, wherein said means to record the location of copies of said required information object records a unique identifier of each information object that it records the location of copies of and supplies said unique identifier when providing information referring to a network location of a copy of an information object.

28. In combination in a computer network, the apparatus of claim 16 and the apparatus of claim 24.

29. A method of providing for the tracking of the transformation of information objects within a communications network, the method including using the content of each input information object to a transformation to compute a unique identifier for that input information object and including each computed unique identifier in the content of each output information object from said transformation so that each said unique identifier can be determined from each said output information object.

30. The method of claim 29, further including computing and storing a unique identifier for each output information object, wherein the stored unique identifiers are associated with each input information object.

31. The method of claim 29 when used in a peer-to-peer network environment.
